(19) United States
(12) Patent Application Publication
(10) Pub. No.: US 2025/0161967 A1
(43) Pub. Date: May 22, 2025

(54) Liquid Dispensing Apparatus

(71) Applicant: JOHNSON & JOHNSON CONSUMER INC., Skillman, NJ (US)

(72) Inventors: William Henry CARR, Phillipsburg, NJ (US); Kelly Gail DUNCAN, Bethlehem, PA (US); Matthew Lawrence NORRIS, Easton, PA (US)

(21) Appl. No.: 18/512,273

(22) Filed: Nov. 17, 2023

Related U.S. Application Data
(60) Provisional application No. 63/384,178, filed on Nov. 17, 2022.

(51) Int. Cl. B05B 11/00; B05B 11/10

(52) U.S. Cl. CPC B05B 11/0044; B05B 11/1023; B05B 11/1059

(57) ABSTRACT

A dispensing apparatus can be configured for dispensing material fluid from a container. The dispensing apparatus can include a collar, a fluid chamber, an actuator, and an air chamber. The collar can be configured to couple to a container defining a cavity configured to hold material. The fluid chamber can be fluid chamber coupled to the collar and configured to receive material from the cavity. The actuator can be movable relative to the collar from a first position to a second position. The actuator can be in fluid communication with the fluid chamber such that the actuator dispenses material from the fluid chamber as the actuator moves from the first position to the second position. The air chamber can be configured to urge the actuator from the second position to the first position.

### CROSS-REFERENCE TO RELATED APPLICATIONS

This application claims priority to U.S. Provisional Application Ser. No. 63/384,178 filed Nov. 17, 2022, the entire contents of which is hereby incorporated by reference herein.

### TECHNICAL FIELD

The present disclosure relates to a hand-operated, fluid-dispensing apparatus, for example, a pump, that may be used in the consumer health and personal care industries.

### BACKGROUND

Hand-operated dispensing pumps can be used to dispense fluids, including bodywash, lotions and other skin and hair care products. Most pumps commercially sold for dispensing fluids are made from various materials, including, for example, a metal compression ring to drive regeneration of the pump actuator back to its starting position after being depressed. Traditional hand-operated dispensing pumps are typically pre-installed on a fluid filled container prior to sale and are disposed of with the container after use. Such pumps using metal return springs are difficult to recycle, which is undesirable or unacceptable to many of today's environmentally conscious consumers.

Thus, there is a need in the art for a hand-operated, fluid dispensing pump that is made from recyclable material and that has parity with the effectiveness of those traditional pumps that use a metal compression ring.

### SUMMARY

A dispensing apparatus can be configured for dispensing material fluid from a container. The dispensing apparatus can include a collar, a fluid chamber, an actuator, and an air chamber. The collar can be configured to couple to a container defining a cavity configured to hold material. The fluid chamber can be fluid chamber coupled to the collar and configured to receive material from the cavity. The actuator can be movable relative to the collar from a first position to a second position. The actuator can be in fluid communication with the fluid chamber such that the actuator dispenses material from the fluid chamber as the actuator moves from the first position to the second position. The air chamber can be configured to urge the actuator from the second position to the first position so as to cause the fluid in the cavity to flow into the fluid chamber.

The dispensing apparatus of claim 1, wherein the air chamber is fluidly isolated from the fluid chamber.

The air chamber can be hermetically sealed. The dispensing apparatus can transition from a first configuration to a second configuration, wherein the air chamber is in fluid communication with ambient air in the first configuration and the air chamber can be fluidly isolated from ambient air in the second configuration. The actuator can be configured to move in a first direction between the first position and the second position and the fluid chamber can be positioned between the actuator and the air chamber in the first direction.

The fluid chamber can be defined by a fluid chamber sidewall and the dispensing apparatus can include an inlet extending through the sidewall, the inlet in fluid communication with the cavity of the container. The air chamber can be elongate along an air chamber central axis, the inlet can be elongate along an inlet central axis, and the air chamber central axis can be parallel to the fluid chamber central axis. The air chamber can be elongate along an air chamber central axis, the fluid chamber can be elongate along a fluid chamber central axis, and the air chamber central axis can be colinear with the fluid chamber central axis. A valve can separate the inlet from the fluid chamber. Movement of the actuator from the first position to the second position can compress air within the air chamber.

The compressed air within the air chamber can urge the actuator toward the first position. The compressed air within the air chamber can be configured to move the actuator to the first position. The dispensing apparatus can include a conduit coupled to the actuator, the fluid from the fluid chamber can be configured to move through the conduit and out of the actuator. The apparatus can include a shaft coupled to the conduit, the shaft movable within the air chamber. The shaft can extend from the fluid chamber into the air chamber. The actuator can be moveable from a locked position to an unlocked position, and the actuator can be configured to dispense fluid from the fluid chamber in the unlocked position. The actuator can be a nozzle. The dispensing apparatus can be made from recyclable material. The air chamber can be defined by a plastic air chamber sidewall.

A dispensing apparatus for dispensing material fluid from a container can include a first assembly, a second assembly, and a valve. The first assembly can include an actuator, a shaft, a fluid chamber and an air chamber that are positioned respectively along a first vertical axis. The second assembly can include a valve and a dip tube that are positioned respectively along a second vertical axis. The valve can connect the first assembly to the second assembly. The first vertical axis and the second vertical axis can be parallel to each other. The actuator can be fixed to a top end of the shaft, wherein a bottom end of the shaft can be movable within the fluid chamber, and wherein the air chamber can be positioned below the fluid chamber and can be separated from the fluid chamber with a seal. A top radial portion of the valve can be connected to the fluid chamber and a bottom portion of the valve can be connected to the dip tube. The dip tube can extend into the material of the container.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 is a side elevation view of a dispensing apparatus coupled to a container in accordance with one embodiment of the present disclosure;

FIG. 2A is a cross-sectional view of the dispensing apparatus of FIG. 1 in a first configuration;

FIG. 2B is a cross-sectional view of the dispensing apparatus of FIG. 1 in a second configuration;

FIG. 2C cross-sectional view of the dispensing apparatus of FIG. 1 in a third configuration;

FIG. 3 is a cross-sectional view of the dispensing apparatus of FIG. 1;

FIG. 4 is a cross-sectional view of a receptacle of FIG. 1;

FIG. 5 is an exploded cross-sectional view of the dispensing apparatus of FIG. 1;

FIG. 6 is a cross-sectional view of a portion of the dispensing apparatus of FIG. 1;

FIG. 7 is a perspective view of a conduit and shaft of FIG. 1;

FIG. 8 is a perspective view of a seal of FIG. 1;

FIG. 9 is a perspective view of the conduit and shaft of FIG. 7 and the seal of FIG. 8 in a first position;

FIG. 10 is a perspective view of the conduit and shaft of FIG. 7 and the seal of FIG. 8 in a second position;

FIG. 11 is a perspective view of the actuator of FIG. 1;

FIG. 12 is a perspective view of the actuator lock of FIG. 1;

FIG. 13 is a side elevation view of a dispensing apparatus coupled to a container in accordance with another embodiment of the present disclosure;

FIG. 14 is a cross-sectional view of the dispensing apparatus of FIG. 13 in a transport configuration;

FIG. 15 is a cross-sectional view of the dispensing apparatus of FIG. 1 in a first configuration;

FIG. 16 is a cross-sectional view of the dispensing apparatus of FIG. 13 in a second configuration;

FIG. 17 is a cross-sectional view of the dispensing apparatus of FIG. 13 in a third configuration;

FIG. 18 is a cross-sectional view of a receptacle of FIG. 13;

FIG. 19 is a perspective view of a conduit and seal of FIG. 13 with the seal in a first position;

FIG. 20 is a perspective view of a conduit and seal of FIG. 13 with the seal in a second position;

FIG. 21 is a perspective view of the seal of FIG. 13;

FIG. 22 is a perspective view of a vessel of FIG. 13;

FIG. 23 is a cross-sectional view of the vessel of FIG. 13;

FIG. 24 is a perspective view of a collar of FIG. 13;

FIG. 25 is a perspective view of an actuator of FIG. 13;

FIG. 26 is a cross-sectional view of the actuator of FIG. 13;

FIG. 27 is a cross-sectional view of a portion of the dispensing apparatus of FIG. 13;

FIG. 28 is a perspective view of a seal of FIG. 13;

FIG. 29 is a cross-sectional view of the seal of FIG. 13; and

FIG. 30 is a perspective view of the safety of FIG. 13.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

Disclosed herein are embodiments of a dispensing apparatus. The dispensing apparatus may be fully recyclable. Full recyclability may be achieved by having all components of the dispensing apparatus molded out of recyclable material. The recyclable material can be plastic. At least some components of the dispensing apparatus can be manufactured from the same material. A fully recyclable dispensing apparatus can still yield the same effectiveness in dispensing fluid products.

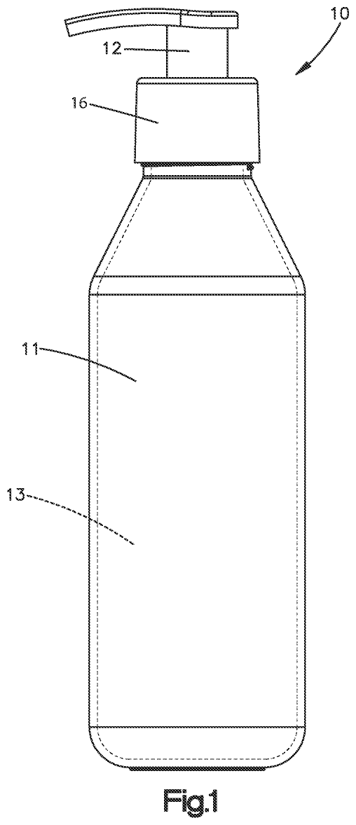

An embodiment of a dispensing apparatus 10 is shown in FIG. 1. In this embodiment, the dispensing apparatus 10 is coupled to a container 11. The container 11 can define a cavity 13 configured to store material. The material can be a fluid. The material can be a fluid having a viscosity of about 1 millipascal-second (mPa·s) to about 10 mPa-s, about 10 mPa-s to about 20 mPa-s, about 20 mPa-s to about 30 mPa-s, about 30 mPa-s to about 40 mPa-s, about 40 mPa-s to about 50 mPa-s, about 50 mPa-s to about 50 mPa-s, about 60 mPa-s to about 70 mPa-s, about 70 mPa-s to about 80 mPa-s, or greater than 80 mPa-s. The dispensing apparatus 10 can be configured to dispense material from the cavity 13 to a user.

The dispensing apparatus 10 can include an actuator 12 configured to eject material from the cavity 13. The actuator 12 can be engageable by a user. The actuator 12 can be movable relative to the container 11. Movement of the actuator 12 relative to the container 11 can dispense material out of the cavity 13. The actuator can be a nozzle. A nozzle may be a cylindrical, round or other shaped spout used at the end of a pump or dispensing apparatus to direct or control the dispensing of a fluid. The actuator 12 may be any object that is capable of being attached to a bottle, tube or other container for the purpose of pumping the fluid contained therein. Other examples of actuators may include a pump, injector, or siphon.

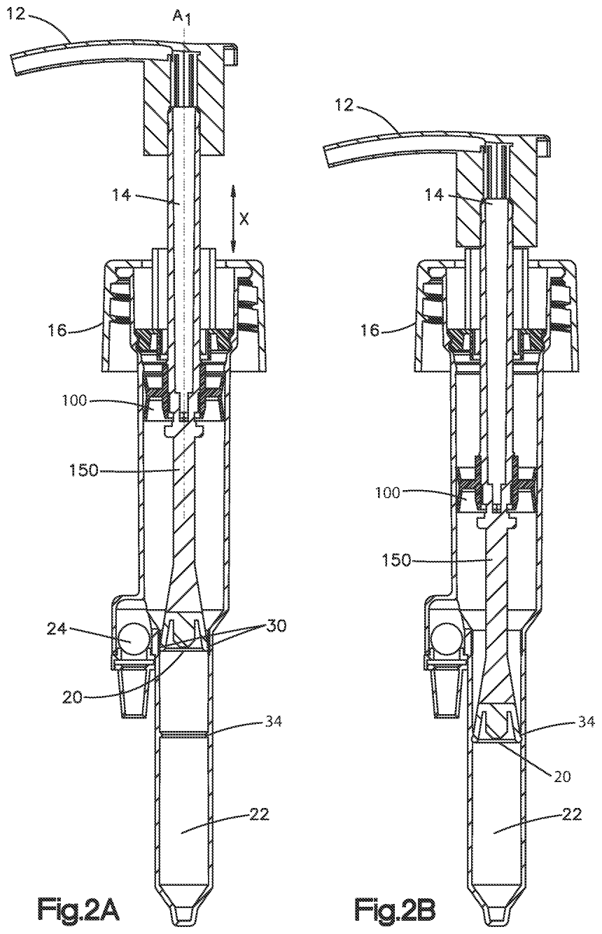

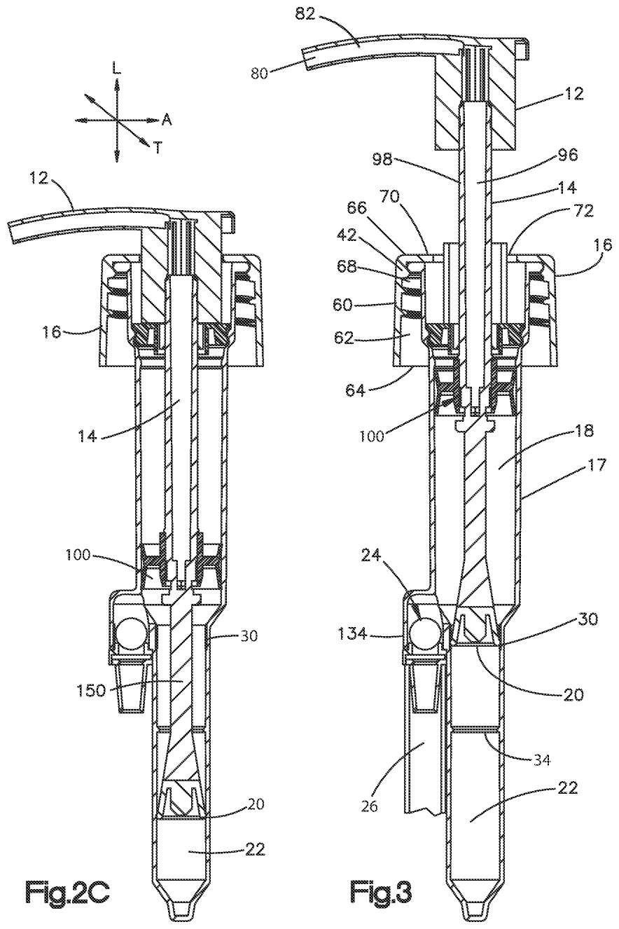

Referring to FIGS. 2A-2C, the actuator 12 can be movable relative to a collar 16. The actuator 12 can be moveable along an actuation axis A₁. The actuation axis A₁ can extend in a longitudinal direction L. In some examples, the actuator 12 can translate along the actuation axis A₁. In other examples, the actuator 12 can rotate about the actuation axis A₁ as the actuator 12 moves along the actuation axis A₁. The actuator 12 can move from a transport position (FIG. 2A) to a first position (FIG. 2B). The actuator 12 can move from the first position to a second position (FIG. 2C). A user can apply a force to the actuator 12 to move the actuator from the first position to the second position. The actuator 12 can dispense material from the container 11 as the actuator 12 moves from the first position toward the second position. The first position can be an initial position. The second position can be a dispensing position. The actuator 12 can move in a first direction as the actuator moves from the first position toward the second position. Conversely, the actuator 12 can move in a second direction opposite the first direction as the actuator moves from the second position to the first position. The first direction can be a proximal direction. The second direction can be a distal direction. At least a portion of the actuator 12 can be disposed in an opening in the collar 16 when the actuator 12 is in the second position.

The dispensing apparatus 10 can include a collar 16 coupled to the container 11. The collar 16 can threadedly engage a neck of the container. Referring to FIG. 3, the collar 16 can include an outer wall 60. The outer wall 60 can define a recess 62. The recess 62 can be configured to receive a portion of the container 11. For example, the recess 62 can be configured to receive a neck of the container 11. The recess 62 can extend from a first end 64 toward a second end 66 of the collar 16. The second end 66 can be opposite the first end 64 in the longitudinal direction L. The recess 62 can extend from the first end 64 to the second end 66. The recess 62 can extend through each of the first and second ends 64, 66.

The outer wall 60 can include an engagement feature 68. The engagement feature 68 can be a thread on a surface of the outer wall 60. The engagement feature 68 can be disposed on an inner surface of the outer wall 60. The engagement feature 68 can engage a corresponding engagement feature on the container 11. The engagement feature 68 can be a recess or protrusion that engages the other of a recess or protrusion on the container 11 to couple the collar 16 to the container 11. In other examples, the engagement feature 68 can be on an outer surface of the outer wall 60. The engagement feature 68 can at least temporarily fix the collar 16 to the container 11. The engagement feature 68 may allow air to enter the container 11 as material is removed from the container 11 and dispensed out of the actuator 12. For example, the connection between the engagement feature 68 and the container 11 may not be air tight. The collar 16 can be manufactured from a recyclable material. The collar 16 can be manufactured from polyolefin, high density polyethylene, polyvinyl chloride, polypropylene, or polyethylene terephthalate.

The collar can include an end wall 70 at the second end 66. The end wall 70 can extend inwardly from the outer wall 60. The end wall 70 can extend from the outer wall 60 toward the central axis A₁. The end wall 70 can extend in a lateral direction A. The lateral direction A can be perpendicular to the longitudinal direction L. An opening 72 can extend through end wall 70. The opening 72 can be configured to receive a portion of the actuator 12. The opening 72 can have a maximum dimension in the lateral direction A that is less than a maximum dimension of the recess 62 in the lateral direction A. The actuator 12 can extend through the opening 72. At least a portion of the actuator 12 can be moveable within the collar 16. The actuator 12 can be disposed outside of the opening 72 in the first position. At least a portion of the actuator 12 can be disposed within the opening 72 in the second position.

Still referring to FIG. 3, the collar 16 can include an attaching element 42. The attaching element 42 can be configured to couple to a receptacle 17. The attaching element 42 can be coupled to the outer wall 60. The attaching element 42 can be a protrusion that extends from the outer wall 60 into the recess 62. The attaching element 42 can be a thread that extends from the outer wall 60 to threadedly engage a flange of a receptacle. The attaching element 42 and the outer wall 60 can be a monolithic construct. The attaching element 42 can be spaced from the end wall 70 in the longitudinal direction L.

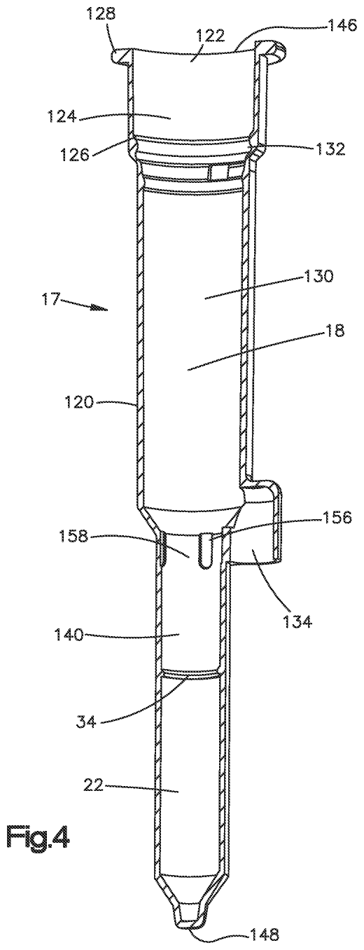

The receptacle 17 can be configured to receive material from the container 11. The receptacle 17 can define a chamber to receive material from the container 11. The actuator 12 can move the material from the chamber out of the dispensing apparatus 10. At least a portion of receptacle 17 can be positioned within the container 11. Referring to FIG. 4, the receptacle 17 can define a fluid chamber 18. The fluid chamber 18 can be configured to receive material from the container 11. The receptacle 17 can include a first end 146 and a second end 148. The first end 146 can be opposite the second end 148 along a central axis. The first end 146 can be opposite the second end 148 in the longitudinal direction L. The receptacle 17 can include a sidewall 120 defining a cavity 122. The fluid chamber 18 can be a portion of the cavity 122. The cavity 122 can extend through the first end 146. The cavity 122 can extend from the first end 146 toward the second end 148. The second end 148 can be closed such that the cavity 122 does not extend through the second end 148. In other examples, the cavity 122 extends through the second end 148.

A first portion 124 of the receptacle 17 can be configured to couple to the collar 16. A securing element 126 can be coupled to the first portion 124 of the receptacle 17. The securing element 126 can be configured to secure an actuator lock to the receptacle 17. The securing element 126 can be a protrusion that extends from an interior surface of the sidewall 120. The cavity 122 can extend through the first portion 124 in the longitudinal direction L.

The first portion 124 can include a coupling element 128 that couples to the attaching element 42. The coupling element 128 can extend from the sidewall 120. The coupling element 128 can be a flange. The coupling element 128 can extend from the sidewall 120 in the lateral direction A away from the central axis A₁. The coupling element 128 can be configured to be positioned between the end wall 70 and the attaching element 42 of the collar 16. In some examples, the coupling element 128 can be snap fit into the space between the end wall 70 and the attaching element 42. In other examples, the coupling element 128 can be rotated to threadedly engage the attaching element 42.

The receptacle 17 can include a second portion 130. The second portion 130 can be adjacent the first portion 124. The second portion 130 can have a width in the lateral direction A that is less than the width of the first portion 124. The cavity 122 can extend through the second portion 130 in the longitudinal direction L. The second portion 130 and the first portion 124 can be colinear. The first portion 124 can be elongate along the central axis A₁. The second portion 130 can be elongate along the central axis A₁. The second portion 130 can be in fluid communication with the first portion 124. The second portion 130 can include the fluid chamber 18. The fluid chamber 18 can be a portion of the second portion 130. The fluid chamber 18 can be a portion of the second portion 130 between a seal 100 and a distal end of the second portion 130. The volume of the second portion 130 can be fixed. The volume of the fluid chamber 18 can change as the seal 100 (FIG. 2B) moves relative to the second portion 130.

The dispensing apparatus can include an actuator lock to lock the position of the actuator relative to the collar 16. The receptacle 17 can include a seat 132 for the actuator lock. The actuator lock seat 132 can be positioned at the interface between the first portion 124 and the second portion 130. The actuator lock seat 132 can be a shoulder. The actuator lock seat 132 can be spaced from the securing element 126 in the longitudinal direction L.

Referring to FIG. 4, the receptacle 17 can include an entryway 134 that provides a fluid path from the cavity 13 into the fluid chamber 18. The entryway 134 can be positioned between the first and second ends 146, 148 of the receptacle 17. The entryway 134 can be elongate along a central axis. The entryway central axis can be parallel to the central axis A₁. The entryway central axis can be parallel to and offset from the central axis A₁. In other examples, the entryway central axis can be transverse to the central axis A₁. The entryway 134 extend through the sidewall 120 of the fluid chamber 18. The entryway 134 can have a width in the lateral direction A that is less than a width of the first portion 124. The entryway 134 can have a width in the lateral direction A that is less than a width of the second portion 130. The entryway 134 can be configured to couple to a dip tube 26 (FIG. 3). The dip tube 26 can be configured to be positioned within the cavity 13. The dip tube 26 can extend to an end of the cavity 13. An outer wall of the entryway 134 can be tapered such that the dip tube 26 can receive at least a portion of the entryway. The dip tube 26 can be flexible.

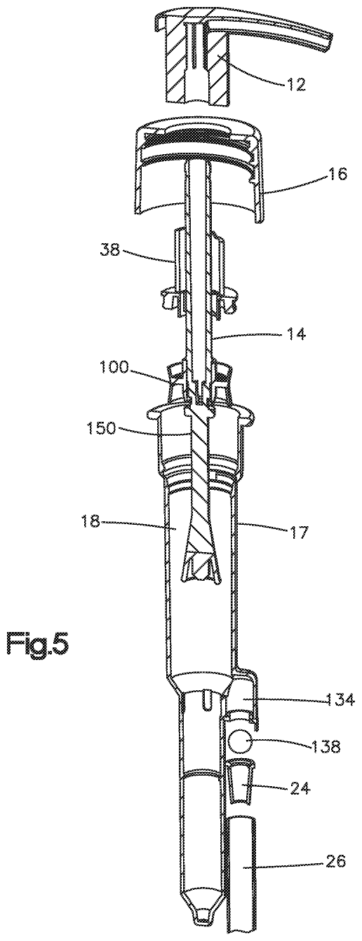

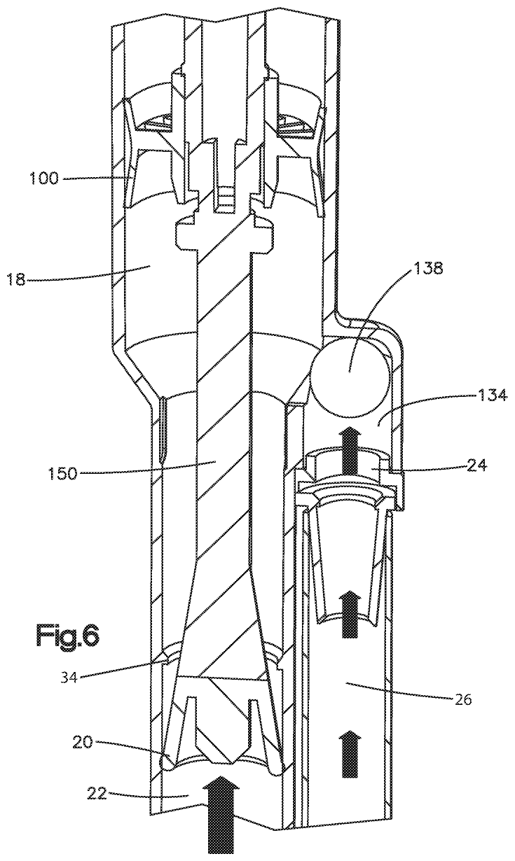

Referring to FIG. 3, the receptacle 17 can be configured to receive a valve 24 to create an air lock within the chamber 18. The entryway 134 can be configured to receive the valve 24. The valve 24 can create an air lock such that a vacuum is created as the actuator 12 moves between the first and second positions. The valve 24 can be a ball valve. In other examples, the valve 24 can be a flap valve or duck bill valve. Movement of the seal 100 within the receptacle 17 can create a vacuum, thereby causing valve 24 to open (FIG. 6) thereby allowing material to enter the fluid chamber 18 through the dip tube 26. A ball 138 (FIG. 5) can unseat from the valve 24 to allow material to enter the fluid chamber 18.

The dispensing apparatus 10 can include an air chamber 22 configured to provide a force to move the actuator 12 from the second position to the first position. Air within the air chamber 22 can be a biasing element that provides a force to move the actuator 12 from the second position to the first position. The receptacle 17 can include the air chamber 22. The air chamber 22 can be a portion of the cavity 122. The air chamber 22 can be defined by a sidewall 140 (FIG. 4). The air chamber 22 can be elongate along a central axis. The air chamber central axis can be coaxial with the central axis A₁. The air chamber 22 can be coaxial with the fluid chamber 18. The air chamber 22 can be coaxial with at least one of the first and second portions 124, 130 of the receptacle 17. The air chamber 22 can be in fluid communication with the fluid chamber 18. The air chamber 22 can be in fluid communication with the second portion 130 of the receptacle 17 such that material from the container 11 can enter least partially into the air chamber 22. The sidewall 140 defining the air chamber 22 and the sidewall 120 defining the fluid chamber 18 can be a monolithic construct. The air chamber 22 can include a retention element 34. The retention element 34 can be configured to retain a shaft 150 within the air chamber 22 (FIG. 2B). The retention element 34 can be a retaining ring. The retention element 34 can extend from the sidewall 140 toward a central axis of the air chamber 22.

The air chamber 22 can be distal to the fluid chamber 18. The fluid chamber 18 can be positioned between the collar 16 and the air chamber 22. The fluid chamber 18 can be positioned between the collar 16 and the air chamber 22 in the longitudinal direction L. The air chamber 22 can have a length in the longitudinal direction L that is less than a length of the fluid chamber 18. In other examples, the air chamber 22 can have a length in the longitudinal direction L that is greater than a length of the fluid chamber 18. The air chamber 22 can include a vent 30 configured to allow air to move from the air chamber into the fluid chamber 18 when the dispensing apparatus 10 is in a first configuration (FIG. 2A). The dispensing apparatus 10 can be in the first configuration during transport of the dispensing apparatus 10. As shown in FIG. 2A, prior to use the actuator 12 is in an elevated position. For transport, elevating the conduit 14 of the dispensing apparatus 10 above air vents 30, also called transport vents, can keep the air chamber 22 from being pressurized, allowing it to adapt to various elevations before being primed. The dispensing apparatus 10 can be in the first configuration prior to priming the dispensing apparatus 10. The vent 30 can allow pressure equalization between the air chamber 22 and the external air without movement of the shaft 150. Equal pressure between the air chamber 22 and the external air can prevent unintended dispensing of material or damage to the dispensing apparatus 10 during transport. For example, the dispensing apparatus 10 can be coupled to a container 11 at a first elevation. The container 11 and dispensing apparatus 10 can then be shipped to a second elevation that is different than the first elevation. The external air pressure can be different at the second elevation than the first elevation. The shaft 150 would need to move equalize pressure within the air chamber 22 at the second elevation with the external air pressure if the air chamber 22 was air locked during transport. The movement of the shaft 150 within the air chamber 22 could cause unintended dispensing of the material from the container 11 or damage to the dispensing apparatus components if the change in pressure was significant. The vent 30 can allow entry of external air from, or exiting of air within, the air chamber 22 without movement of the shaft 150.

Referring to FIG. 4, the vent 30 can be defined by one or more ribs 156 extending from the sidewall 140. The ribs 156 can extend toward the central axis of the air chamber 22. The ribs 156 can extend from an internal surface of the sidewall 140. The ribs 156 can be elongate in the longitudinal direction L. Each rib 156 can be separated from an adjacent rib by a space 158. The space 158 can have a width in the lateral direction A that is greater than a width of the ribs 156.

Referring to FIG. 11, the actuator 12 can include a recess 74 configured to receive at least a portion of a conduit 14. The recess 74 can extend from a first end 76 toward a second end 78 of the actuator 12. The first end 76 can be opposite the second end 78 in the longitudinal direction L. The recess 74 can be a fluid path for material from the container 11 to flow out of the actuator 12. The actuator 12 can include a channel 82 (FIG. 3) in fluid communication with the recess 74. Material can flow through the recess 74 into the channel 82 and out of the actuator opening 80. The recess 74 can be elongate along a recess central axis. The recess central axis can extend in the longitudinal direction. The channel 82 can be elongate along a channel central axis. The channel central axis can be perpendicular to the recess central axis. The recess 74 can be defined by a recess sidewall 84. A locking element 40 can be coupled to the recess sidewall 84. The locking element 40 can be one or more ribs that extend from the recess sidewall 84 into the recess 74.

The recess sidewall 84 can be spaced from a neck sidewall 86 defining the neck 88 of the actuator 12. The neck sidewall 86 can be an outer sidewall. The recess sidewall 84 can be spaced from the neck sidewall 86 in the lateral direction A. The recess sidewall 84 can be coupled to the neck sidewall 86 by a strut 90. The actuator 12 can be manufactured from a recyclable material. The actuator 12 can be manufactured from polyolefin.

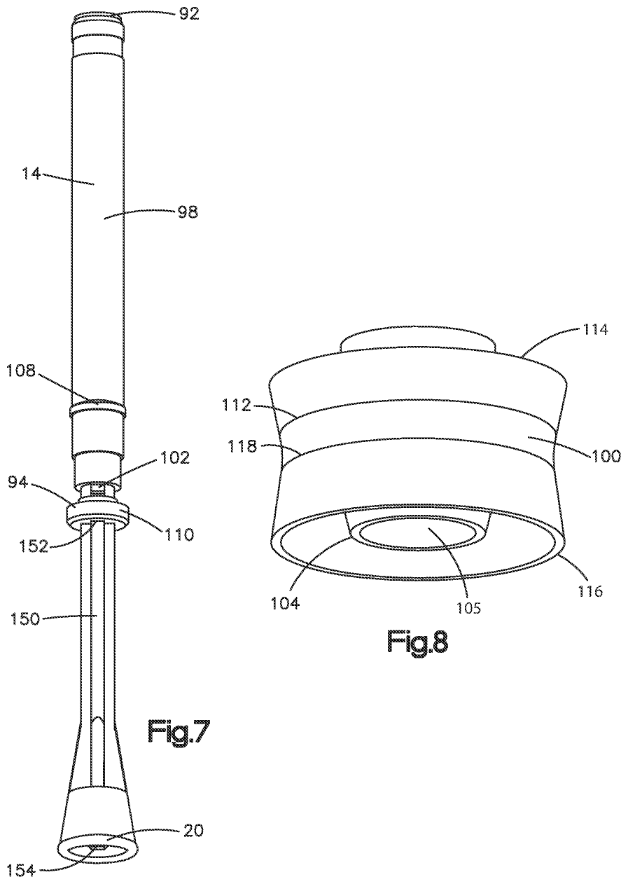

The actuator 12 can be configured to couple to a conduit 14. Referring to FIG. 4, the conduit 14 can provide a fluid path between a fluid chamber 18 and the actuator 12. The conduit 14 can be configured, at use, to slide through the collar 16 and into the fluid chamber 18. In some examples, the conduit 14 and the actuator 12 are a monolithic construct. In other examples, the conduit 14 is detachably coupled to the actuator 12. Referring to FIG. 7, the conduit 14 can include a first end 92 and a second end 94. The first end 92 can be coupled to the actuator 12. The first end 92 can be received in the recess 74 of the actuator 12. In some examples, the conduit 14 is rotationally fixed relative to the actuator 12. In other examples, the conduit 14 is rotatably coupled to the actuator 12. The conduit 14 can be fixed relative to the actuator 12 in the longitudinal direction L. The conduit 14 can move relative to the collar 16 as the actuator 12 moves from the first position to the second position.

Referring to FIG. 7, the conduit 14 can be elongate between the first end 92 and the second end 94. The conduit 14 can include a conduit sidewall 98 that extends from the first end 92 to the second end 94. Referring to FIG. 3, the conduit sidewall 98 can define a channel 96 such that material from the container can flow through the channel 96. The channel 96 can extend from the second end 94 toward the first end 92. The channel 96 can extend through the second end 94. The channel can extend through the first end 92. An inlet 102 (FIG. 7) can be in fluid communication with the channel 96. The inlet 102 can extend through the conduit sidewall 98. In other examples, the inlet 102 can extend through the second end 94. The channel 96 can be elongate in the longitudinal direction L. The inlet 102 can extend through the conduit sidewall 98 in a direction transverse to the longitudinal direction L. The inlet 102 can extend through the conduit sidewall 98 in the lateral direction A. The conduit 14 can be manufactured from a recyclable material. The conduit 14 can be manufactured from polyolefin.

Referring to FIG. 7, a shaft 150 can be configured to be positioned within the air chamber 22. The shaft 150 can create a fluid seal with the sidewall 140 (FIG. 4) of the air chamber 22. The shaft 150 can be movable within the air chamber 22. The shaft 150 can be fixed with respect to the conduit 14 such that movement of the conduit 14 in the longitudinal direction L causes movement of the shaft 150 in the longitudinal direction L. At least a portion of the shaft 150 can move within the air chamber 22 as at least a portion of the conduit 14 moves in the fluid chamber 18. In some examples, the conduit 14 and the shaft 150 are a monolithic construct. In other examples, the conduit 14 and the shaft 150 are separate elements that can be coupled to each other. The shaft 150 can be detachably coupled to the conduit 14. The shaft 150 can be fixed to the conduit 14. The shaft 150 can be rotationally fixed relative to the conduit 14. The second seal seat 110 can be a flange that extends outwardly from the shaft 150 and the conduit 14.

The shaft 150 can include a first end 152 and a second end 154. The first end 152 can be opposite the second end 154 in the longitudinal direction L. The first end 152 can be coupled to the second end 94 of the conduit 14. The first end 152 can be coupled to the second seal seat 110. The second end 154 can create a fluid seal with the sidewall 140 of the air chamber 22. A seal 20 can sealingly engage the sidewall 140. The seal 20 can prevent the passage of air or fluid between the seal and the sidewall 140. The seal 20 can be coupled to the shaft 150. The seal 20 can be coupled to the second end 154 of the shaft 150. The seal 20 can be detachably coupled to the shaft 150.

The second end 154 can have a width in the lateral direction A that is greater than a width of the first end 152. The width of the second end 154 can be greater than a width of the conduit 14. The shaft 150 can be tapered inwardly in a first direction from the second end 154 toward the first end 152. The second end 154 can be aligned with the vents 30 in the longitudinal direction L when the dispensing apparatus is in the first configuration (FIG. 2A). The shaft 150 can establish an air seal with the sidewall 140 when shaft 150 moves away from the vents 30. Air within the air chamber 22 can be locked in the air chamber 22 once the air lock is established. The mass of air within the air chamber 22 can be fixed once the air lock is established. The second end 154 can move into engagement with the retention element 34 when the dispensing apparatus 10 is in a second configuration (FIG. 2B). A force can be applied to the actuator 12 to move the second end 154 of the shaft 150 in the longitudinal direction L past the retention element 34. At least one of the retention element 34 and the second end 154 of the shaft 150 can flex to allow the second end 154 past the retention element 34. A force can be applied to the actuator 12 to move the shaft 150 relative to the air chamber 22 to a third configuration (FIG. 2C). Movement of the shaft 150 in the longitudinal direction L toward the second end 148 of the air chamber 22 can decrease the effective volume of the air chamber 22. Decreasing the volume of the air chamber 22 can increase the pressure within the air chamber 22. The pressure within the air chamber 22 can urge the shaft 150 toward the second configuration. The pressure within the air chamber 22 can be the force that moves the shaft 150, and therefore the actuator 12, toward the second configuration. The shaft 150 can engage the retention element 34 as the shaft 150 moves from the third configuration to the second configuration. The retention element 34 can prevent the shaft 150 from returning to the first configuration.

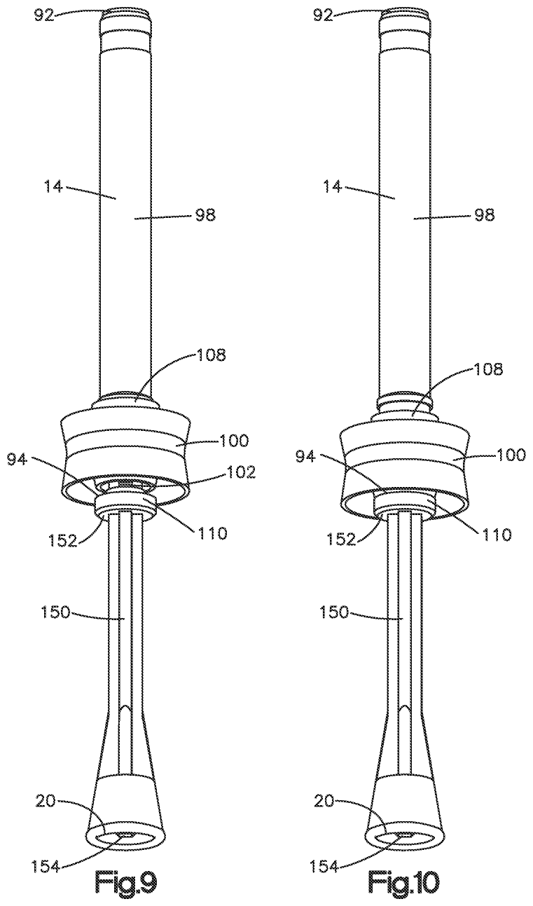

A seal 100 can be configured to prevent material from the fluid chamber 18 from entering the inlet 102 of the conduit 14. In some examples, the seal 100 is a diaphragm. The seal 100 can transition from a sealed configuration where the seal 100 occludes the inlet 102 to an unsealed configuration where the seal 100 allows material to enter the inlet 102. The seal 100 can be movably coupled to the conduit 14. The seal 100 can be movable relative to the conduit 14 in the longitudinal direction L. In other examples, the seal 100 can be movable relative to the conduit 14 in the lateral direction A. Referring to FIG. 8, the seal 100 can include an inner wall 104 defining a recess 105. The recess 105 can be configured to receive the conduit 14. The inner wall 104 can be configured to form a fluid seal with the conduit sidewall 98. The seal 100 can be moveable relative to the conduit 14 from a first position (FIG. 10) to a second position (FIG. 9). The seal 100 can be in the sealed configuration when the seal 100 is in the first position. The seal 100 can be in the unsealed configuration when the seal 100 is in the second position. The seal 100 can be rubber. The seal 100 can be a flexible material.

The conduit 14 can be configured to limit movement of the seal 100 relative to the conduit 14. Referring to FIG. 7, the conduit 14 can include a first seal seat 108 configured to prevent movement of the seal 100 in the longitudinal direction L relative to the conduit 14. In some examples, the seal 100 contacts the first seal seat 108 when the seal is in the first position. In other examples, the seal 100 moves toward the first seal seat 108 as the seal 100 transitions from the second position to the first position but the seal 100 does not contact the first seal seat 108. A first end of the inner wall 104 can contact the first seal seat 108 when the seal 100 is in the first position. The first seal seat 108 can be a ridge that extends from the conduit sidewall 98 of the conduit 14. The first seal seat 108 can extend around a perimeter of the conduit sidewall 98.

The conduit 14 can include a second seal seat 110 configured to prevent movement of the seal 100 in the longitudinal direction L relative to the conduit 14. In some examples, the seal 100 contacts the second seal seat 110 when the seal 100 is in the second position. In other examples, the seal 100 moves toward the second seal seat 110 as the seal 100 transitions from the first position to the second position but the seal 100 does not contact the second seal seat 110. The inner wall 104 can contact the second seal seat 110 when the seal 100 is in the second position. The second seal seat 110 can be a ridge that extends from the conduit sidewall 98 of the conduit 14. The second seal seat 110 can extend around a perimeter of the conduit sidewall 98. The seal 100 can be disposed between the first and second seal seats 108, 110. The inlet 102 can be positioned between the first and second seal seats 108, 110.

Referring to FIG. 8, the seal 100 can include an outer wall 112 configured to engage a sidewall 120 of the fluid chamber 18. The outer wall 112 can provide a fluid seal with the fluid chamber 18. The seal 100 can include a first end 114 and a second end 116. The first end 114 can be opposite the second end 116 in the longitudinal direction L. The outer wall 112 can include a central portion 118 between the first end 114 and the second end 116. The central portion 118 can have a width in the lateral direction A that is less than a width of the first end 114. The width of the central portion 118 can be less than the width of the second end 116. The first and second ends 114, 116 can have equal widths. At least one of the first and second ends 114, 116 can contact a sidewall 120 of the fluid chamber 18. At least one of the first and second ends 114, 116 can create a fluid seal with the fluid chamber 18. The outer wall 112 can have a length in the longitudinal direction L that is less than a length of the inner wall 104.

The seal 100 can be movable relative to the fluid chamber 18. The seal 100 can be movable within the fluid chamber 18. The seal 100 can be movable within the fluid chamber 18 relative to the receptacle 17 in the longitudinal direction L. The seal 100 can be movable relative to the conduit 14. The seal 100 can be movable relative to the conduit 14 in the longitudinal direction L. A first friction force can be required to move the seal 100 relative to the sidewall 120 of the fluid chamber 18. A second friction force can be required to move the seal 100 relative to the conduit 14. The first friction force can be greater than the second friction force. The seal 100 can be in the first position when the actuator 12 is in the first configuration (FIG. 2B).

A user can apply a force to the actuator 12 to move the actuator from the first position to the second position. Depressing the actuator 12 a certain distance can dispense a desired amount of fluid. Such depression distance, denoted as “X” in FIG. 2A, may be about 10 millimeters (mm), 11 mm, 12 mm, 13 mm, 14 mm, 15 mm, 16 mm, 17 mm or 18 mm. In one embodiment, the depression distance is about 14 mm. When the actuator 12 is released, the pressurized air chamber 22 can generate enough force to replenish the fluid chamber 18 at an acceptable rate of speed. As the actuator 12 moves to the second position, the first friction force can be greater than the second friction force such that the seal 100 remains fixed relative to the sidewall 120 of the fluid chamber 18 as the conduit 14 moves relative to the sidewall 120. The conduit 14 can move relative to the seal 100 until the seal 100 is in the second position and the inner wall 104 contacts the second seal seat 110. The inlet 102 material from the fluid chamber 18 can enter the inlet 102 when the seal 100 is in the second position. With the seal 100 in the second position, the second seal seat 110 can apply a force to the seal 100 such that the seal 100 and the conduit 14 move together in the longitudinal direction L. The valve 24 can create an air tight seal at the entryway 134 as the actuator 12 moves to the second position. The outer wall 112 of the seal 100 can create an air tight seal at the other end of the fluid chamber 18. As the seal 100 moves relative to the fluid chamber 18 to a dispensing configuration (FIG. 2C), the pressure within the fluid chamber 18 can increase due to the air tight seals at the two ends of the fluid chamber 18. Material within the fluid chamber 18 can flow through the inlet 102 and out of the actuator 12 in response to the increase in pressure. The material within the fluid chamber 18 can be gas, fluid, solid, or semi-solid.

As the actuator 12 moves from the second position (FIG. 2C) to the first position (FIG. 2B), the first friction force can be greater than the second friction force such that the conduit 14 moves relative to the seal 100 from the second position toward the first position. The seal 100 can move to the first position as the conduit 14 moves relative to the seal 100. The seal 100 can occlude the inlet 102 when the seal 100 is in the first position. The conduit 14 can continue to move toward the first position when the seal 100 is occluding the inlet 102. This can create a vacuum within the fluid chamber 18 as the volume of the chamber between the seal 100 and the inlet 102 increases. The vacuum can cause the valve 24 to open thereby allowing material from the container to enter the fluid chamber 18. The engagement of the collar 16 with the container 11 may not be air tight such that air from outside the container can enter the cavity 13 of the container to replace the material being evacuated through the dispensing apparatus 10.

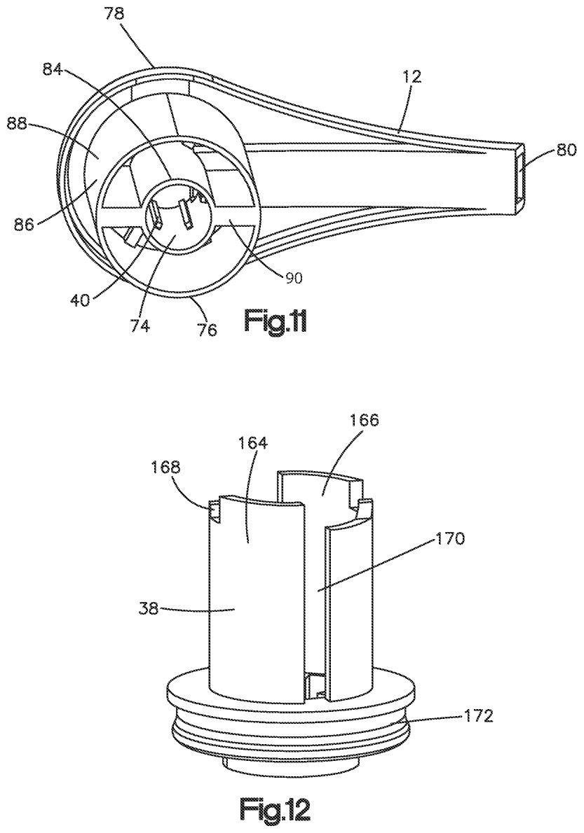

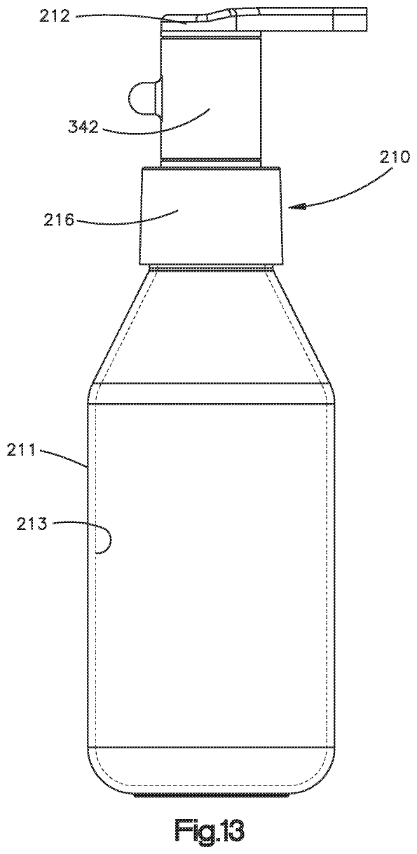

Referring to FIG. 12, the dispensing apparatus 10 can include an actuator lock 38 configured to prevent movement of the actuator 12. The actuator lock 38 can be configured to prevent movement of the actuator 12 from the first position to the second position. One of the actuator 12 and the actuator lock 38 can be movable relative to the other of the actuator 12 and the actuator lock 38 from a locked configuration to an unlocked configuration. The actuator 12 can be moveable from the first position to the second position in the unlocked configuration. The actuator lock 38 can prevent the actuator 12 moving from the first position to the second position in the locked configuration. In some examples, the actuator lock 38 locks the actuator in the first position. In other examples, the actuator lock 38 locks the actuator 12 in the second position.

The actuator lock 38 can include a sidewall 164. The sidewall 164 can define an opening 166 to receive the conduit 14. The conduit 14 can be movable relative to the actuator lock 38 when the dispensing apparatus 10 is in the unlocked configuration. The sidewall 164 can engage the strut 90 of the actuator 12 in the locked configuration. The sidewall 164 can include an engagement feature 168 that engages the strut 90. The engagement feature 168 can be a notch. The engagement feature 168 can be a notch in an end of the sidewall 164. The actuator lock 38 can include a passageway 170. The strut 90 can move within the passageway 170 as the actuator 12 moves from the first position to the second position. The actuator lock 38 can include an anchor 172 configured to fix the actuator lock 38 relative to the receptacle 17. The anchor 172 can engage the securing element 126 of the receptacle 17. The anchor 172 can be positioned between the securing element 126 and the seat 132 to fix the actuator lock 38 relative to the receptacle 17 in the longitudinal direction L. The anchor 172 can have a width that is greater than a width of the fluid chamber 18.

The actuator 12 can be rotatable relative to the actuator lock 38 to transition between the locked and unlocked configurations. The actuator 12 can be rotatable about the central axis A₁ relative to the actuator lock 38. The dispensing apparatus 10 can be in the unlocked configuration when the strut 90 is aligned with the passageway 170 such that the strut 90 moves into the passageway 170 as the actuator 12 moves from the first position to the second position. The dispensing apparatus 10 can be in the locked configuration when the strut 90 is aligned with the engagement feature 168 such that the strut 90 will engage the engagement feature 168 as the actuator 12 moves from the first position to the second position.

Referring to FIG. 13, another embodiment of a dispensing apparatus 210 is shown. The dispensing apparatus 210 can be configured to dispense material out of a container 211. The dispensing apparatus 210 can be coupled to the container 211. The container 211 can define a cavity 213 configured to store material. The material can be a fluid. The material can be a fluid having a viscosity of about 1 millipascal-second (mPa·s) to about 10 mPa-s, about 10 mPa-s to about 20 mPa-s, about 20 mPa-s to about 30 mPa-s, about 30 mPa-s to about 40 mPa-s, about 40 mPa-s to about 50 mPa-s, about 50 mPa-s to about 50 mPa-s, about 60 mPa-s to about 70 mPa-s, about 70 mPa-s to about 80 mPa-s, or greater than 80 mPa-s.

The dispensing apparatus 210 can include an actuator 212 configured to eject material from the cavity 213. The actuator 212 can be movable relative to the container 211. Movement of the actuator 212 relative to the container 211 can dispense material out of the cavity 213. The actuator can be a nozzle. A nozzle may be a cylindrical, round or other shaped spout used at the end of a pump or dispensing apparatus to direct or control the dispensing of a fluid. The actuator 212 may be any object that is capable of being attached to a bottle, tube or other container for the purpose of pumping the fluid contained therein. Other examples of actuators may include a pump, injector, or siphon.

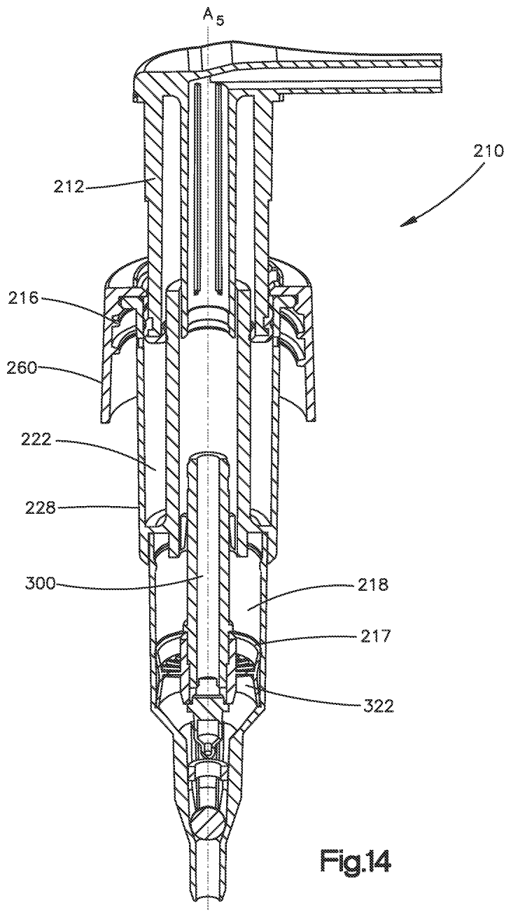

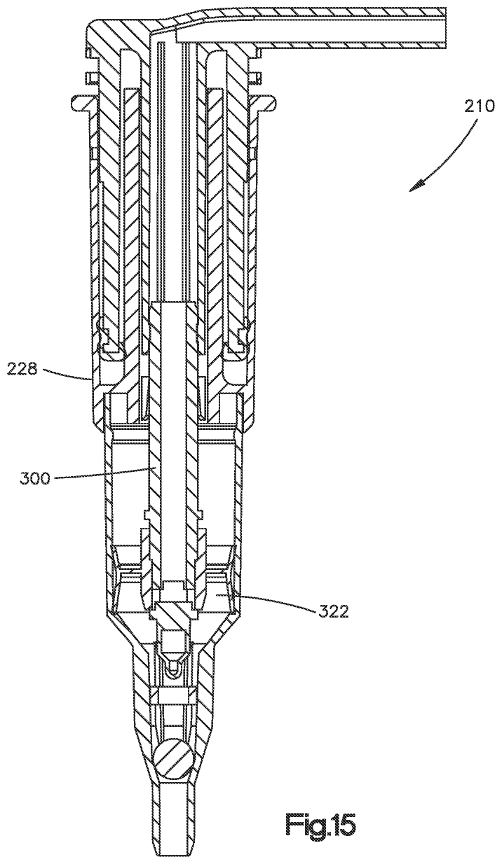

Referring to FIGS. 14-17, the actuator 212 can be movable relative to a collar 16. The actuator 212 can be moveable along an actuation axis A₅ (FIG. 14). The actuation axis A₅ can extend in a longitudinal direction L. In some examples, the actuator 212 can translate along the actuation axis A₅. In other examples, the actuator 212 can rotate about the actuation axis A₅ as the actuator 212 moves along the actuation axis A₅. The actuator 212 can move from a first position (FIG. 14) to a second position (FIG. 15). The first position can be a transport position. The second position can be a primed position. The actuator 212 can couple to a conduit 300 as the actuator 212 moves from the first position to the second position. The actuator 212 can move in a first direction as the actuator 212 moves from the first position to the second position. The first direction can be a priming direction. The actuator 212 can move toward a collar 216 as the actuator 212 moves in the first direction.

The actuator 212 can move from the second position to a third position (FIG. 16). The third position can be a ready position. The actuator 212 and the conduit 300 can move together as the actuator 212 moves from the second position to the third position. The actuator 212 can move in a second direction as the actuator 212 moves from the second position to the third position. The second direction can be opposite the first direction. The second direction can be a return direction. A distance between the actuator 212 and the collar 216 in the longitudinal direction L can be greater in the first position than in the third position.

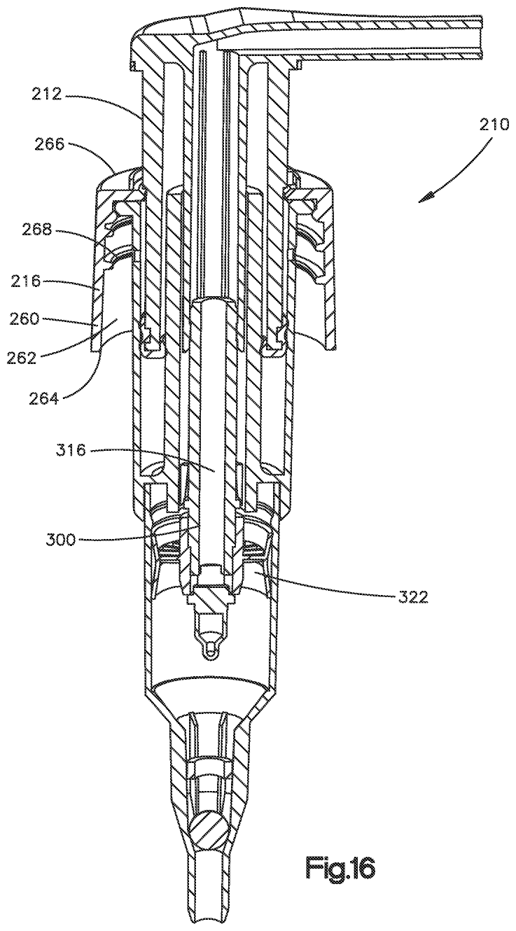

The actuator 212 can move from the third position to fourth position (FIG. 17). The fourth position can be a dispensing position. The actuator 212 and the conduit 300 can move together as the actuator 212 moves from the third position to the fourth position. The actuator 212 can move in a third direction as the actuator 212 moves from the third position to the fourth position. The third direction can be a dispensing direction. The third direction can be the same as the priming direction. The distance between the actuator 212 and the collar 216 in the longitudinal direction L can be the same in the second position and the fourth position.

A user can apply a force to the actuator 212 to move the actuator 212 in the dispensing direction. The actuator 212 can dispense material from the container 211 as the actuator 212 moves from the third position toward the fourth position. At least a portion of the actuator 212 can be disposed in an opening in the collar 216 when the actuator 212 is in the dispensing position.

The dispensing apparatus 210 can include a collar 216 configured to couple to the container 211. The collar 216 can threadedly engage a neck of the container. Referring to FIG. 16, the collar 216 can include an outer wall 260. The outer wall 260 can define a recess 262. The recess 262 can be configured to receive a portion of the container 211. For example, the recess 262 can be configured to receive a neck of the container 211. The recess 262 can extend from a first end 264 toward a second end 266 of the collar 216. The second end 266 can be opposite the first end 264 in the longitudinal direction L. The recess 262 can extend from the first end 264 to the second end 266. The recess 262 can extend through each of the first and second ends 264, 266.

The outer wall 260 can include an engagement feature 268. The engagement feature 268 can be a thread on a surface of the outer wall 260. The engagement feature 268 can be disposed on an inner surface of the outer wall 260. The engagement feature 268 can engage a corresponding engagement feature on the container 211. The engagement feature 268 can be a recess or protrusion that engages the other of a recess or protrusion on the container 211 to couple the collar 216 to the container 211. In other examples, the engagement feature 268 can be on an outer surface of the outer wall 260. The engagement feature 268 can at least temporarily fix the collar 216 to the container 211. The engagement feature 268 may allow air to enter the container 211 as material is removed from the container 211 and dispensed out of the actuator 212. For example, the connection between the engagement feature 268 and the container 211 may not be air tight. The collar 216 can be manufactured from a recyclable material. The collar 216 can be manufactured from polyolefin, high density polyethylene, polyvinyl chloride, polypropylene, or polyethylene terephthalate.

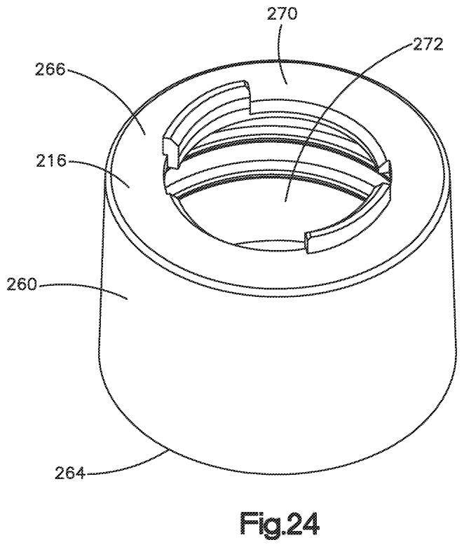

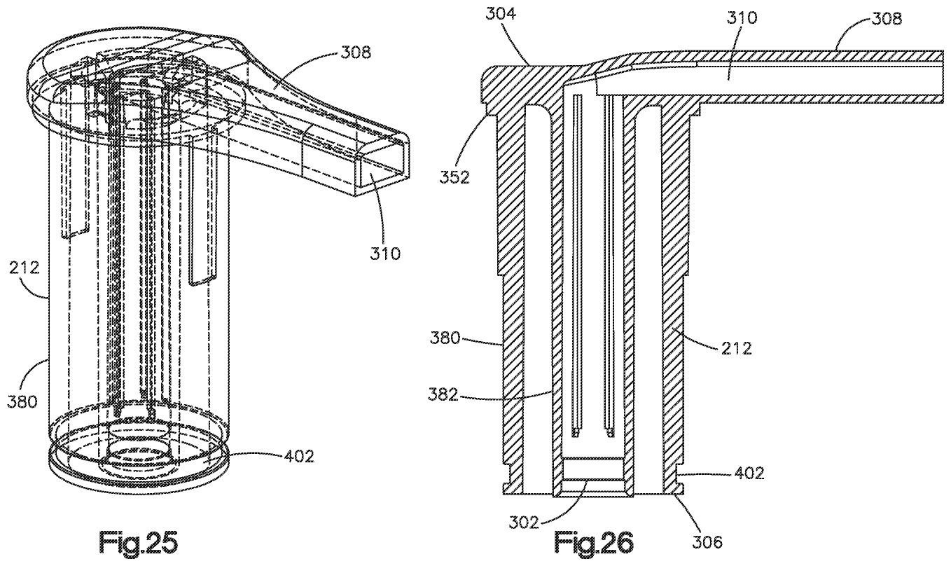

Referring to FIG. 24, the collar can include an end wall 270 at the second end 266. The end wall 270 can extend inwardly from the outer wall 260. The end wall 270 can extend from the outer wall 260 toward the central axis A₅. The end wall 270 can extend in the lateral direction A. An opening 272 can extend through end wall 270. The opening 272 can be configured to receive a portion of the actuator 212. The opening 272 can have a maximum dimension in the lateral direction A that is less than a maximum dimension of the recess 262 in the lateral direction A. The actuator 212 can extend through the opening 272. At least a portion of the actuator 212 can be moveable within the collar 216. A portion of the actuator 212 can be disposed within the opening 272 in the ready position. At least a portion of the actuator 212 can be disposed within the opening 272 in the dispensing position.

Referring to FIG. 17, the collar 216 can include an attaching element 276 configured to couple to a vessel. The attaching element 276 can be coupled to the outer wall 260. The attaching element 276 can be a protrusion that extends from the outer wall 260 into the recess 262. The attaching element 276 can be a thread that extends from the outer wall 260 to threadedly engage a flange of the vessel. The attaching element 276 and the outer wall 260 can be a monolithic construct.

Referring to FIG. 14, the dispensing apparatus 210 can include an air chamber 222 configured to provide a force to move the actuator 212 from the dispensing position to the ready position. The air chamber 222 can move the actuator 212 in the return direction. Air within the air chamber 222 can be a biasing element that provides a force to move the actuator 212 from the fourth position to the third position. The air chamber central axis can be coaxial with the central axis A₁.

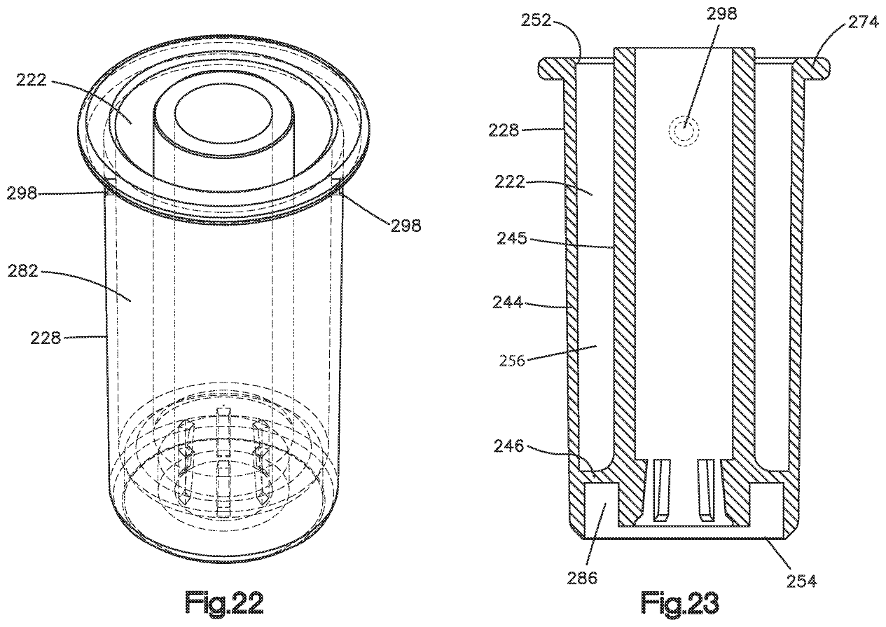

Referring to FIGS. 22 and 23, a vessel 228 can define the air chamber 222. The vessel 228 can include a first vessel sidewall 244 and a second vessel sidewall 245 that define the air chamber 222. The first vessel sidewall 244 can be spaced from the second sidewall in the lateral direction A. The first vessel sidewall 244 can be spaced from the second vessel sidewall 245 in the transverse direction T. The air chamber 222 can be positioned between the first and second vessel sidewalls 244, 245. An end wall 246 can be coupled to the first and second vessel sidewalls 244, 245. The end wall 246 can be positioned between a first end 252 and a second end 254 of the vessel 228. The first end 252 can be spaced from the second end 254 in the longitudinal direction L. The second end 254 can be further from the collar 216 than the first end 252. The first and second vessel sidewalls 244, 245 and the end wall 246 can define a recess 256. The air chamber 222 can be a portion of the recess 256.

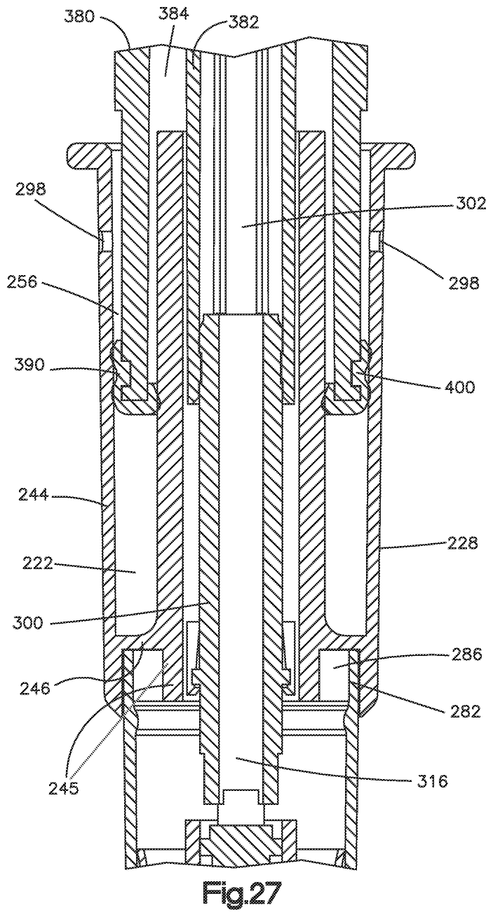

Referring to FIG. 27, the air chamber 222 can be positioned between a portion of the actuator 212 and the end wall 246. The recess 256 can be open at the first end 252. At least a portion of the actuator 212 can be positioned within the recess 256. A portion of the actuator 212 can be movable within the recess 256. The actuator 212 can include a first actuator sidewall 380. The actuator sidewall 380 can be an outer sidewall of the actuator 212. The actuator 212 can include a second actuator sidewall 382. The first actuator sidewall 380 can be spaced from the second actuator sidewall 382 in the transverse direction T. The first actuator sidewall 380 can be spaced from the second actuator sidewall 382 in the lateral direction A. The actuator 212 can include an actuator recess 384 between the first and second actuator sidewalls 380, 382. The actuator recess 384 can be configured to receive a portion of the vessel 228. At least a portion of the second vessel sidewall 245 can be positioned in the actuator recess 384. The first actuator sidewall 380 can be positioned in the vessel recess 256 when the second vessel sidewall 245 is positioned in the actuator recess 384. The first actuator sidewall 380 can be spaced from the first vessel sidewall 244 in the lateral direction A. The first actuator sidewall 380 can be spaced from the second vessel sidewall 245 in the lateral direction A. The first actuator sidewall 380 can be spaced from each of the first and second vessel sidewalls 244, 245 in the lateral direction A.

The dispensing apparatus 210 can include a seal 390 that prevents air from entering or exiting the air chamber 222. Air within the air chamber 222 can be compressed as the actuator 212 moves relative to the vessel 228. Air within the air chamber 222 can be compressed as the actuator 212 moves in the dispensing direction relative to the vessel 228. The pressure within the air chamber can increase as the air is compressed. The air pressure within the air chamber can increase as a force is applied to move the actuator 212 in the dispensing direction. The compressed air can urge the actuator 212 in the return direction. The compressed air can move the actuator 212 in the return direction when the force is removed from the actuator 212.

The seal 390 can form a fluid seal with at least one of the first and second vessel sidewalls 244, 245. The seal 390 can form a hermetic seal with at least one of the first and second vessel sidewalls 244, 245. The seal 390 can form a fluid seal with the first actuator sidewall 380. The seal 390 can be a resiliently deformable material. The seal 390 can be rubber.

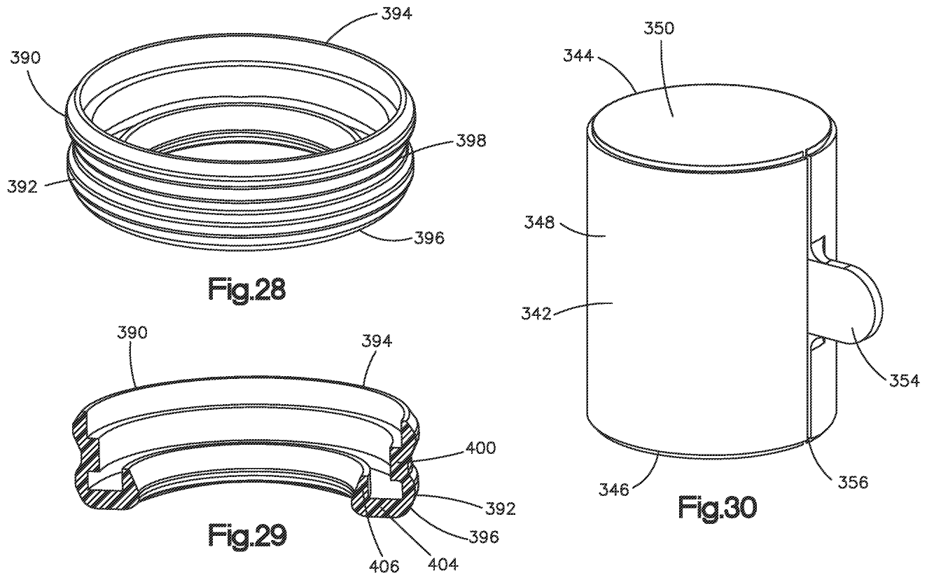

Referring to FIGS. 28 and 29, the seal 390 can include an outer wall 392 configured to engage the first vessel sidewall 244 of the fluid chamber 151. The outer wall 392 can provide a fluid seal with the first vessel sidewall 244. The seal 390 can include a first end 394 and a second end 396. The first end 394 can be opposite the second end 396 in the longitudinal direction L. The outer wall 392 can include a central portion 398 between the first end 394 and the second end 396. The central portion 398 can have a width in the lateral direction A that is less than a width of the first end 394. The width of the central portion 398 can be less than the width of the second end 396. The first and second ends 394, 396 can have equal widths. At least one of the first and second ends 394, 396 can contact the first vessel sidewall 244. At least one of the first and second ends 394, 396 can create a fluid seal with the first vessel sidewall 244. The outer wall 392 can be positioned between the first vessel sidewall 244 and the first actuator sidewall 380.

Referring to FIG. 29, the seal 390 can include a retainer 400 configured to engage the actuator 212. The retainer 400 can be coupled to the outer wall 392. The retainer 400 and outer wall 392 can be a monolithic construct. The retainer 400 can extend from the outer wall 392 in the lateral direction A. The retainer 400 can extend toward the central axis A₁. The retainer 400 can be coupled to a mating element 402 of the first actuator sidewall 380 (FIG. 26). One of the retainer 400 and the mating element 402 can be a protrusion and the other of the retainer 400 and the mating element 402 can be a recess configured to receive the protrusion. The retainer 400 can engage the mating element 402 to fix the position of the seal 390 relative to the actuator 212 in the longitudinal direction L.

The seal 390 can include a seal end wall 404. The seal end wall 404 can be coupled to the outer wall 392. The seal end wall 404 can be coupled to the second end 396 of the outer wall 392. The end wall 404 can have a thickness in the lateral direction A that is greater than a thickness of the retainer 400. The retainer 400 can be spaced from the end wall 404 in the longitudinal direction L. The end wall 404 can have a thickness in the lateral direction A that is greater than a thickness of the first actuator sidewall 380.

The seal 390 can include an inner wall 406 that extends from the end wall 404. The inner wall 406 can extend from the end wall 404 toward the first end 394 of the seal 390. The inner wall 406 can be positioned between the first actuator sidewall 380 and the second vessel sidewall 245. The inner wall 406 can have a length in the longitudinal direction L that is less than the length of the outer wall. The inner wall 406, end wall 404, and outer wall 392 can envelop an end of the first actuator sidewall 380. The inner wall 406, end wall 404, and outer wall 392 can be a monolithic construct. The inner wall 406 can from a fluid seal with the second vessel sidewall 245. The seal 390 can be movable relative to the vessel 228. The seal 390 can be fixed relative to the actuator 212. The air chamber 222 can be defined by the first and second vessel sidewalls 244, 245, the vessel end wall 246 and the seal 390. The volume of the air chamber 222 can change as the seal 390 moves relative to the vessel 228.

Referring to FIG. 23, the air chamber 222 can include a vent 298 configured to allow air to move out of the air chamber 222 when the dispensing apparatus 210 is in a first configuration (FIG. 14). The vent 298 can be an opening in the first vessel sidewall 244. The vent 298 can be an opening in the second vessel sidewall 245. The dispensing apparatus 210 can be in the first configuration during transport of the dispensing apparatus 210. As shown in FIG. 14, prior to use the actuator 212 is in an elevated position. For transport, elevating the seal 390 of the dispensing apparatus 210 above the vent 298 can keep the air chamber 222 from being pressurized, allowing it to adapt to various elevations before being primed. The dispensing apparatus 210 can be in the first configuration prior to priming the dispensing apparatus 210. The vent can allow pressure equalization between the air chamber 222 and the external air without movement of the actuator 212. Equal pressure between the air chamber 222 and the external air can prevent unintended dispensing of material or damage to the dispensing apparatus 210 during transport. For example, the dispensing apparatus 210 can be coupled to the container 211 at a first elevation. The container 211 and dispensing apparatus 210 can then be shipped to a second elevation that is different than the first elevation. The external air pressure can be different at the second elevation than the first elevation. The actuator 212 would need to move equalize pressure within the air chamber 222 at the second elevation with the external air pressure if the air chamber 222 was air locked during transport. The movement of the actuator 212 within the air chamber 222 could cause unintended dispensing of the material from the container 211 or cause damage to the dispensing apparatus components if the change in pressure was significant. The vent 298 can allow entry of external air into, or exiting of air from, the air chamber 222 without movement of the actuator 212.

The vessel 228 can be coupled to the collar 216. Referring to FIG. 23, the vessel 228 can include a vessel attaching element 274. The vessel attaching element 274 can be configured to engage the collar attaching element 276 (FIG. 17). The vessel attaching element 274 can be a flange. The vessel attaching element 274 can be coupled to the first vessel sidewall 244. The vessel attaching element 274 can be coupled to the first end 252 of the first vessel sidewall 244. The vessel attaching element 274 can be coupled to a proximal end of the first vessel sidewall 244 and the proximal end of the second vessel sidewall 245 can be proximal to the vessel attaching element 274. The vessel attaching element 274 can engage the collar attaching element 276 to fix the position of the vessel 228 relative to the collar 216 in the longitudinal direction L. The vessel 228 can be rotatable relative to the collar 216 when the vessel attaching element 274 is engaged with the collar attaching element 276.

Referring to FIG. 17, the collar attaching element 276 can be coupled to the collar outer wall 260. The collar attaching element 276 can be a protrusion that extends from the outer wall 260 into the recess 262. The collar attaching element 276 can be a thread that extends from the outer wall 260 to threadedly engage the vessel attaching element 274. The collar attaching element 276 and the outer wall 260 can be a monolithic construct. The collar attaching element 276 can be spaced from the end wall 270 in the longitudinal direction L. The vessel attaching element 274 can be snap fit into engagement with the collar attaching element 276.

Referring to FIG. 14, the dispensing apparatus 210 can include receptacle 217 configured to receive material from the container 211. The receptacle 217 can define a fluid chamber 218 configured to receive fluid from the cavity 213 of the container 211. The actuator 212 can dispense fluid from the fluid chamber 218. The actuator 212 can move the material from the chamber out of the dispensing apparatus 210. At least a portion of the receptacle 217 can be positioned within the container 211. In some examples, there is no energy source within the fluid chamber 218. In some examples, the vessel 228 does not include an energy source.

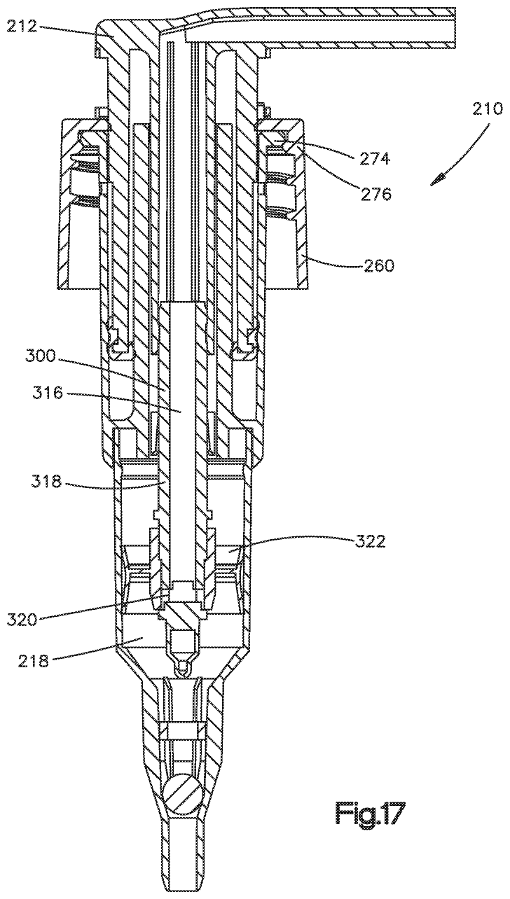

Referring to FIG. 18, the receptacle 217 can include a first end 278 and a second end 280. The first end 278 can be opposite the second end 280 along a central axis A₃. The first end 278 can be opposite the second end 280 in the longitudinal direction L. The receptacle 217 can include a receptacle sidewall 282 defining a channel 284. The fluid chamber 218 can be a portion of the channel 284. The channel 284 can extend through the first end 278. The channel 284 can extend from the first end 278 toward the second end 280. The channel 284 can extend through the second end 280. In other examples, the second end 280 is closed such that the channel 284 does not extend through the second end 280.

The receptacle 217 can be configured to couple to the vessel 228. Referring to FIG. 23, the vessel 228 can include a vessel engagement feature 286 configured to engage the receptacle 217. The vessel engagement feature 286 can be a recess configured to receive a portion of the receptacle 217. The recess can be positioned between the first and second vessel sidewalls 244, 245. The recess can extend from the second end 254 toward the first end 252 of the vessel 228. The recess can extend from the second end 254 to the end wall 246. The vessel engagement feature 286 can be configured to receive the first end 278 of the receptacle sidewall 282. In some examples, the first end 278 of the receptacle sidewall 282 is press fit into the vessel engagement feature 286. In other embodiments, the vessel engagement feature 286 is coupled to the receptacle 217 by adhesive, weld, or fastener. Referring to FIG. 27, the receptacle sidewall 282 can engage the vessel end wall 246 when the receptacle sidewall 282 is engaged with the vessel engagement feature 286.

Referring to FIG. 18, the receptacle 217 can include a second portion 288 adjacent the fluid chamber 218. The second portion 288 can have a width in the lateral direction A that is less than the width of the fluid chamber 218. The channel 284 can extend through the second portion 288 in the longitudinal direction L. Fluid can flow through the second portion 288 and into the fluid chamber 218.

The receptacle 217 can include a valve to create an air lock within the fluid chamber 218. The valve can be positioned in the second portion 288. The second portion 288 can include a guiding feature 290 for the valve. The guiding feature 290 can be one or more ribs that extend from the receptacle sidewall 282 into the channel 284. The ribs can be elongate in the longitudinal direction L. The ribs can be spaced from each other about a central axis A₃ of the receptacle 217 such that material from the container can flow in the space between the ribs into the fluid chamber 218. In some examples, the valve is a ball valve. In other examples, the valve is a flap valve. A ball 292 can be received within a spaced defined by the guiding feature 290. The ball 292 can engage a valve seat to create an air lock in the fluid chamber 218. The valve seat can be a portion of the receptacle sidewall 282 defining an inlet 294. The ball 292 can be moveable relative to the receptacle 217. The guiding feature 290 can restrict the ball 292 to movement in the longitudinal direction L. The ball 292 can engage the valve seat when the actuator 212 is in the fourth position. The receptacle 217 can include a restrictor 296 configured to maintain the valve within the space defined by the guiding feature 290. The restrictor 296 can be positioned within the spaced defined by the guiding feature 290. The restrictor 296 can be fixed relative to the receptacle 217 in the longitudinal direction L. The restrictor 296 can be fixed to the guiding feature 290. The restrictor 296 can be a ring having a central opening with a diameter that is smaller than a diameter of the ball 292 such that the ball cannot pass through the central opening of the restrictor 296. The restrictor 296 can be configured to allow material from the container 211 to flow through the central opening.

The inlet 294 can be configured to allow material from the container 211 to flow into the fluid chamber 218. In some examples, the inlet 294 is disposed within the cavity 213 of the container 211 such that the material directly enters into the inlet 294. In other examples, a fluid communication device is coupled to the inlet 294. Material can flow through the fluid communication device and into the inlet 294. The fluid communication device can be a dip tube. The fluid communication device can be a straw. The fluid communication device can be a pipe.

The fluid chamber 218 can be distal to the air chamber 222. The air chamber 222 can be positioned between the collar 16 and the fluid chamber 218. The air chamber 222 can be positioned between the collar 16 and the fluid chamber 218 in the longitudinal direction L. The air chamber 222 can have a length in the longitudinal direction L that is greater than a length of the fluid chamber 218. In other examples, the air chamber 222 can have a length in the longitudinal direction L that is less than a length of the fluid chamber 218.

Referring to FIG. 16, the actuator 212 can be configured to couple to a conduit 300 such that fluid flows from the fluid chamber 218 through the conduit 300 and into the actuator 212. Referring to FIG. 26, the actuator 212 can include a recess 302 configured to receive at least a portion of the conduit 300. The recess 302 can extend from a first end 304 toward a second end 306 of the actuator 212. The first end 304 can be opposite the second end 306 in the longitudinal direction L. The recess 302 can define a fluid path for material from the container 211 to flow out of the actuator 212. A spout 308 of the actuator 212 can include a channel 310 in fluid communication with the recess 302. Material from the container 211 can flow into the fluid chamber 218, through the conduit 300, and out of the actuator 212. The recess 302 can be defined by the second actuator sidewall 382.

Referring to FIG. 17, the conduit 300 can provide a fluid path between the fluid chamber 218 and the actuator 212. In some examples, the conduit 300 and the actuator 212 are a monolithic construct. In other examples, the conduit 300 is detachably coupled to the actuator 212. Referring to FIG. 19, the conduit 300 can include a first end 312 and a second end 314. The first end 312 can be coupled to the actuator 212. In some examples, the first end 312 is press fit into the actuator recess 302. The first end 312 can be received within the actuator recess 302. The conduit 300 can be rotationally fixed relative to the actuator 212. In other examples, the conduit 300 is rotatably coupled to the actuator 212. The conduit 300 can be fixed relative to the actuator 212 in the longitudinal direction L. The conduit 300 can move relative to the collar 216 as the actuator 212 moves from the first position to the second position.

The conduit 300 can be elongate between the first end 312 and the second end 314. Referring to FIG. 17, the conduit 300 can include a channel 316 such that material from the container can flow through the channel 316. The channel 316 can extend from the first end 312 toward the second end 314. The channel 316 can extend through the first end 312. The conduit 300 can include a conduit sidewall 318. An inlet 320 (FIG. 19) can be in fluid communication with the channel 316. The inlet 320 can extend through the conduit sidewall 318. In other examples, the inlet 320 can extend through the second end 314. The channel 316 can be elongate in the longitudinal direction L. The inlet 320 can extend through the conduit sidewall 318 in a direction transverse to the longitudinal direction L. The inlet 320 can extend through the conduit sidewall 318 in the lateral direction A.

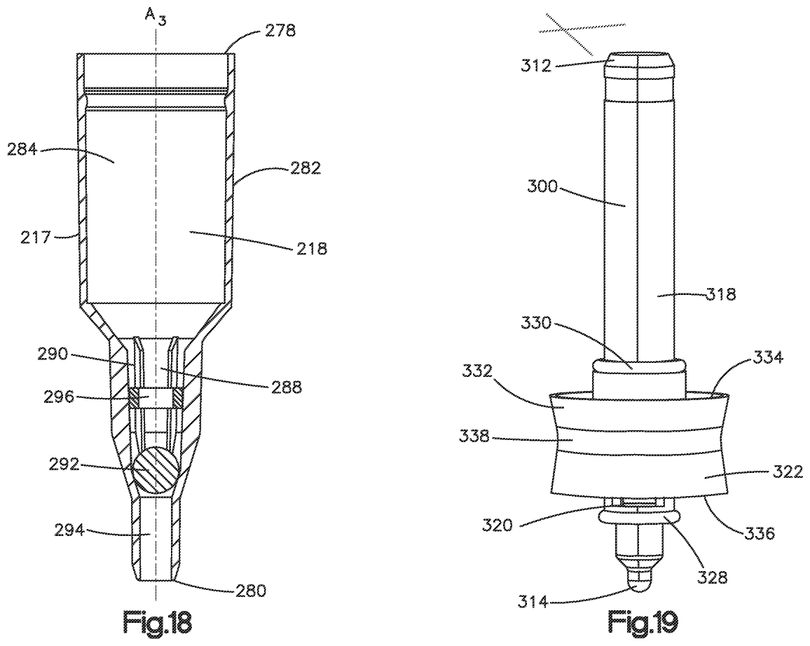

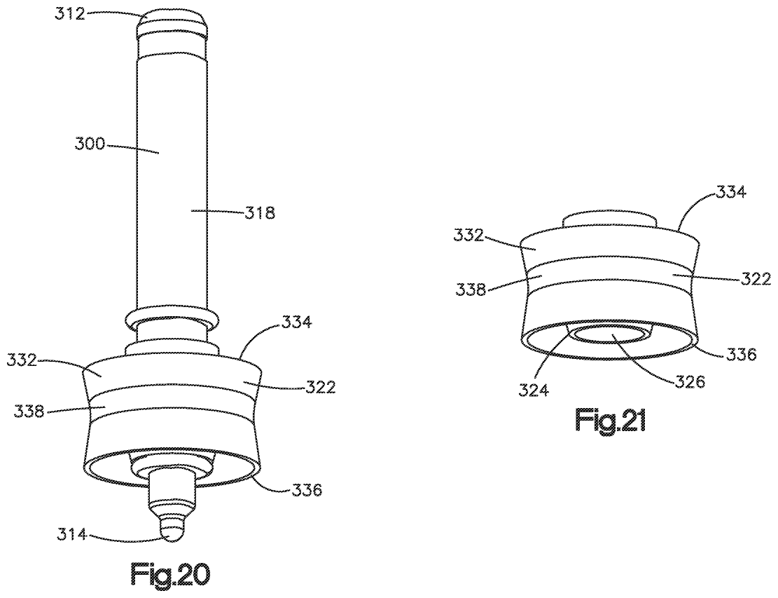

A seal 322 can be configured to prevent material from the fluid chamber 218 from entering the inlet 320 of the conduit 300. In some examples, the seal 322 is a diaphragm. The seal 322 can transition from a sealed configuration where the seal 322 occludes the inlet 320 (FIG. 20) to an unsealed configuration where the seal 322 allows material to enter the inlet 320 (FIG. 19). The seal 322 can be movably coupled to the conduit 300. The seal 322 can be movable relative to the conduit 300 in the longitudinal direction L. In other examples, the seal 322 can be movable relative to the conduit 300 in the lateral direction A. The seal 322 can include a seal inner wall 324 defining a seal channel 326 (FIG. 21). The seal channel 326 can be configured to receive the conduit 300. The seal inner wall 324 can be configured to form a fluid seal with the conduit sidewall 318. The seal 322 can be moveable relative to the conduit 300 from a first position (FIG. 20) to a second position (FIG. 19). The seal 322 can be in the sealed configuration when the seal 322 is in the first position. The seal 322 can be in the unsealed configuration when the seal 322 is in the second position. The seal 322 can be rubber. The seal 322 can be a flexible material.

The conduit 300 can be configured to limit movement of the seal 322 relative to the conduit 300. The conduit 300 can include a first seal seat 328 configured to prevent movement of the seal 322 in the longitudinal direction L relative to the conduit 300. In some examples, the seal 322 contacts the first seal seat 328 when the seal is in the first position. In other examples, the seal 322 moves toward the first seal seat 328 as the seal 322 transitions from the second position to the first position but the seal 322 does not contact the first seal seat 328. The seal inner wall 324 can contact the first seal seat 328 when the seal 322 is in the first position. The first seal seat 328 can be a ridge that extends from the conduit sidewall 318 of the conduit 300. The first seal seat 328 can be a ridge that extends from the conduit sidewall 318 in the lateral direction A.

The conduit 300 can include a second seal seat 330 configured to prevent movement of the seal 322 in the longitudinal direction L relative to the conduit 300. In some examples, the seal 322 contacts the second seal seat 330 when the seal is in the second position. In other examples, the seal 322 moves toward the second seal seat 330 as the seal 322 transitions from the first position to the second position but the seal 322 does not contact the second seal seat 330. The seal inner wall 324 can contact the second seal seat 330 when the seal 322 is in the second position. The second seal seat 330 can be a ridge that extends from the conduit sidewall 318 of the conduit 300. The second seal seat 330 can be a ridge that extends from the conduit sidewall 318 of the conduit 300 in the lateral direction A. The seal 322 can be disposed between the first and second seal seats 328, 330.

The seal 322 can include a seal outer wall 332 configured to engage the receptacle sidewall 282. The seal outer wall 332 can provide a fluid seal with the receptacle sidewall 282. The seal 322 can include a first end 334 and a second end 336. The first end 334 can be opposite the second end 336 in the longitudinal direction L. The seal outer wall 332 can include a central portion 338 between the first end 334 and the second end 336. The central portion 338 can have a width in the lateral direction A that is less than a width of the first end 334. The width of the central portion 338 can be less than the width of the second end 336. The first and second ends 334, 336 can have equal widths. At least one of the first and second ends 334, 336 can contact the receptacle sidewall 282 of the fluid chamber 218. At least one of the first and second ends 334, 336 can create a fluid seal with the receptacle sidewall 282. The seal outer wall 332 can have a length in the longitudinal direction L that is less than a length of the seal inner wall 324.

The seal 322 can be movable relative to the receptacle 217. The seal 322 can be movable relative to the receptacle 217 in the longitudinal direction L. The seal 322 can be movable relative to the conduit 300. The seal 322 can be movable relative to the conduit 300 in the longitudinal direction L. A first friction force can be required to overcome friction between the seal 322 and the receptacle sidewall 282 to move the seal 322 relative to the receptacle sidewall 282. A second friction force can be required to overcome the friction between the seal 322 and the conduit 300 to move the seal 322 relative to the conduit 300. The first friction force can be greater than the second friction force. The seal 322 can be in the first position when the actuator 212 is in the third position (FIG. 16).

A user can apply a force to the actuator 212 to move the actuator from the third position to the fourth position (FIG. 17). As the actuator 212 begins to move from the third position to the fourth position, the first friction force can be greater than the second friction force such that the seal 322 remains fixed relative to the receptacle sidewall 282 of the fluid chamber 218 as the conduit 300 moves relative to the receptacle sidewall 282. The conduit 300 can move relative to the seal 322 until the seal 322 is in the second position and the seal inner wall 324 contacts the second seal seat 330. Fluid from the fluid chamber 218 can enter the inlet 320 when the seal 322 is in the second position. With the seal 322 in the second position, the second seal seat 330 can apply a force to the seal 322 such that the seal 322 and the conduit 300 move together in the longitudinal direction L. The ball 292 can be engaged with the inlet 294 creating an air tight seal at one end of the fluid chamber 218 as the actuator 212 moves to the fourth position. The seal outer wall 332 can create an air tight seal at the other end of the fluid chamber 218. As the seal 322 moves relative to the receptacle 217 to a dispensing configuration (FIG. 17), the pressure within the fluid chamber 218 can increase due to the air tight seals at the two ends of the fluid chamber 218. Material within the fluid chamber 218 can flow through the inlet 320 and out of the actuator 212 in response to the increase in pressure. The material within the fluid chamber 218 can be gas, fluid, solid, or semi-solid.

As the actuator 212 moves from the fourth position (FIG. 17) to the first third position (FIG. 16), the first friction force can be greater than the second friction force such that the conduit 300 moves relative to the seal 322 from the second position toward the first position. The seal 322 can move to the first position as the conduit 300 moves relative to the seal 322. The seal 322 can occlude the inlet 320 when the seal 322 is in the first position. The conduit 300 can continue to move toward the third position when the seal 322 is occluding the inlet 320. This can create a vacuum within the fluid chamber 218 as the volume of the chamber between the seal 322 and the inlet 320 increases. The vacuum can cause the ball 292 to disengage from the inlet 320 thereby allowing material from the container to enter the fluid chamber 218. The engagement of the neck of the container with the collar 216 may not be air tight such that air from outside the container can enter the cavity 213 of the container to replace the material being evacuated through the dispensing apparatus 210.

The dispensing apparatus 210 can include a safety 342 configured to prevent dispensing of material from the actuator 212. Referring to FIG. 30, the safety 342 can include a first end 344 and a second end 346 opposite the first end 344 in the longitudinal direction L. The safety 342 can include a safety sidewall 348 that extends from the first end 344 to the second end 346. The safety sidewall 348 can define a channel 350. The channel 350 can extend from the first end 344 to the second end 346. The safety 342 can be configured to engage the actuator 212 (FIG. 13). The channel 350 can be configured to receive a portion of the actuator 212. The channel 350 can be configured to receive the first actuator sidewall 380. The actuator 212 can include a ridge 352 (FIG. 26) configured to engage the safety first end 344. The safety second end 346 can be configured to engage the collar 216. The safety 342 can be a physical obstruction that prevents movement of the actuator 212 toward the collar 216. The safety 342 can include a release 354. The release 354 can be a tab engageable by a user. Applying a force to the release 354 can break a frangible section 356 of the safety sidewall 348. The safety 342 can be decoupled from the actuator 212 when the frangible section 356 is broken. It should be understood that the safety sidewall 348 does not require a frangible section. For example, the safety 342 can be coupled to the actuator 212 by adhesive, weld, or friction fit such that the safety 342 can be removed without breaking a frangible section. The actuator 212 can move relative to the collar once the safety 342 is removed.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

When values are expressed as approximations by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, reference to values stated in ranges includes each and every value within that range.

Throughout this specification, words are to be afforded their normal meaning as would be understood by those skilled in the relevant art. However, so as to avoid misunderstanding, the meanings of certain terms will be specifically defined or clarified.

It is to be appreciated that certain features of the present disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the present disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure. Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

What is claimed:

1. A dispensing apparatus for dispensing fluid from a container, the dispensing apparatus comprising:
a collar coupled to a container, the container defining a cavity configured to hold fluid;
a fluid chamber coupled to the collar, the fluid chamber configured to receive fluid from the cavity;
an actuator movable relative to the collar from a first position to a second position, wherein as the actuator moves from the first position to the second position, the actuator is placed in fluid communication with the fluid chamber to dispense the fluid from the fluid chamber; and
an air chamber configured to urge the actuator from the second position to the first position so as to cause the fluid in the cavity to flow into the fluid chamber.

2. The dispensing apparatus of claim 1, wherein the air chamber is fluidly isolated from the fluid chamber.

3. The dispensing apparatus of claim 1, wherein the air chamber is hermetically sealed.

4. The dispensing apparatus of claim 1, wherein the dispensing apparatus transitions from a first configuration to a second configuration, wherein the air chamber is in fluid communication with ambient air in the first configuration and the air chamber is fluidly isolated from ambient air in the second configuration.

5. The dispensing apparatus of claim 1, wherein the actuator is configured to move in a first direction between the first position and the second position and wherein the fluid chamber is positioned between the actuator and the air chamber in the first direction.

6. The dispensing apparatus of claim 5, wherein the fluid chamber is defined by a fluid chamber sidewall and the dispensing apparatus further comprises an inlet extending through the sidewall, the inlet in fluid communication with the cavity of the container.

7. The dispensing apparatus of claim 6, wherein the air chamber is elongate along an air chamber central axis, the inlet is elongate along an inlet central axis, and the air chamber central axis is parallel to the fluid chamber central axis.

8. The dispensing apparatus of claim 1, wherein the air chamber is elongate along an air chamber central axis, the fluid chamber is elongate along a fluid chamber central axis, and the air chamber central axis is colinear with the fluid chamber central axis.

9. The dispensing apparatus of claim 6, wherein a valve separates the inlet from the fluid chamber.

10. The dispensing apparatus of claim 1, wherein movement of the actuator from the first position to the second position compresses air within the air chamber.

11. The dispensing apparatus of claim 10, wherein the compressed air within the air chamber urges the actuator toward the first position.

12. The dispensing apparatus of claim 10, wherein the compressed air within the air chamber is configured to move the actuator to the first position.

13. The dispensing apparatus of claim 1, further comprising a conduit coupled to the actuator, the fluid from the fluid chamber configured to move through the conduit and out of the actuator.

14. The dispensing apparatus of claim 13, further comprising a shaft coupled to the conduit, the shaft movable within the air chamber.

15. The dispensing apparatus of claim 14, wherein the shaft extends from the fluid chamber into the air chamber.

16. The dispensing apparatus of claim 1, wherein the actuator is moveable from a locked position to an unlocked position, and the actuator is configured to dispense fluid from the fluid chamber in the unlocked position.

17. The dispensing apparatus of claim 1, wherein the actuator is a nozzle.

18. The dispensing apparatus of claim 1, wherein the dispensing apparatus is made from recyclable material.

19. The dispensing apparatus of claim 1, wherein the air chamber is defined by a plastic air chamber sidewall.

20. The dispensing apparatus of claim 1, wherein the actuator is configured to move in a first direction between the first position and the second position and wherein the air chamber is positioned between the collar and the fluid chamber in the first direction.

21. The dispensing apparatus of claim 20, wherein the air chamber includes a first end and a second end spaced from the first end in the first direction,
wherein the actuator includes a first actuator end and a second actuator end spaced from the first actuator end in the first direction,
wherein the second actuator end is positioned between the first and second ends of the air chamber when the actuator is in the second position.

22. The dispensing apparatus of claim 1, wherein the actuator is configured to move in a first direction between the first position and the second position and the actuator includes a first actuator end and a second actuator end spaced from the first actuator end in the first direction,
wherein the air chamber is defined by a first sidewall, a second sidewall, an endwall coupled to each of the first and second sidewalls, and the second actuator end.

23. The dispensing apparatus of claim 22, wherein the second sidewall defines an opening and at least a portion of the actuator is disposed within the opening.

24. The dispensing apparatus of claim 22, further comprising a seal coupled to the second actuator end, the seal providing a fluid seal with the first and second sidewalls.
